(19) United States
(12) Patent Application Publication
(10) Pub. No.: US 2015/0068713 A1
(43) Pub. Date: Mar. 12, 2015

(54) Solder Powder

(71) Applicant: Erbslöh Aluminium GmbH, Velbert (DE)

(72) Inventors: Norbert William Sucke, Duisburg (DE); Lothar Löchte, Hilden (DE); Martin Grzesik, Dortmund (DE)

(21) Appl. No.: 14/388,324

(22) PCT Filed: Mar. 20, 2013
(86) PCT No.: PCT/EP2013/000843

§ 371 Date: Sep. 26, 2014

(30) Foreign Application Priority Data
Mar. 26, 2012 (DE) 10 2012 006 121.8
Mar. 26, 2012 (DE) 202012003090.6

(51) Int. Cl. B23K 35/02; F28D 7/16; F28F 21/08; B23K 35/28

(52) U.S. Cl. CPC B23K 35/0244; B23K 35/025; B23K 35/286; B23K 35/288; F28D 7/16; F28F 21/084
USPC 165/133; 420/548; 420/540; 420/582; 148/24; 165/173

(57) ABSTRACT

The invention relates to a solder powder for connecting components made of aluminium or aluminium alloys by brazing, in particular a brazing powder for connecting heat exchanger components. The solder powder consists of powder particles on an aluminium-silicon base having a weight fraction of more than 12% by weight of silicon, wherein the powder particles have been produced by a rapid solidification and contain uniformly distributed silicon primary crystal precipitations in the eutectic aluminium-silicon alloy structure. Coating with such a solder powder leads to a uniform distribution of the silicon on the surface of the component coated with solder powder and thus to the same good soldering results.

### BACKGROUND

The invention concerns a solder powder for connecting components of aluminum or aluminum alloys by brazing, especially a brazing powder for the connecting of heat exchanger components.

Components for heat exchangers, especially for use in motor vehicles, are preferably made of aluminum or an aluminum alloy, since such heat exchangers have a relatively low weight and the aluminum material has a high corrosion resistance. Known heat exchangers are made from extruded flat tube sections which are arranged in parallel with each other and joined at their two ends to a manifold. Between adjacent sides of two flat tube sections there is fastened to them a lamella, see EP 1 179 167 B1. The connection between the section tubes and the lamellas, as well as that between the section tubes and the manifolds, is done by a brazed connection. For the brazing process a solder is needed which produces the intimate connection between the two aluminum base materials of the aluminum components being joined, as well as a flux which serves to remove the oxide skin present on the aluminum components. At least one member of the joint is coated with the solder and flux prior to the brazing process. Depending on the coating method, a mixture of solder, flux and binder is applied to the surface of one of the aluminum components being brazed, see claims 9 and 10 of DE 197 44 734 A1 as well as claim 22 of DE 198 59 735 A1. The choice of suitable brazing solders for the connection of heat exchanger components is limited, since the base material of the components consists of aluminum or an aluminum alloy. Thus, the brazing solder must have a lower melting interval than the base materials of the aluminum components. Aluminum or aluminum alloys that melt in the range >600° C. are generally used for aluminum components. Brazing solders on an aluminum-silicon base are suitable for the connection of these aluminum components, preferably AlSi(7-13) alloys with a melting interval of 575° C. to 615° C.

The use of such AlSi(7-13) alloy solder is disclosed, for example, in document EP 292 565 B1. In the heat exchangers described there, the lamellas used are made from a 3003 aluminum alloy, which is clad with a 4343 aluminum alloy, i.e., with an AlSi(7-8) solder alloy cladding. The flat hollow section used consists of a 1050 aluminum alloy. The brazing is done in an oven under inert gas atmosphere, the lamella material being connected to the contact sites with the flat tubular section. The solder cladding of the lamellas ensures a uniform solder coating, but the drawback is that the additional cladding requires a relatively large layer thickness. Furthermore, the cladding consumes more solder than is needed for the brazing, since solder is only needed for the brazed connection at the contact sites between lamella and multi-chamber hollow profiles.

Another possibility is shown by document DE 197 44 734 A1. Here, an AlSi(7.5) solder alloy is applied along with flux powder and binder powder to the surface of the flat tubes. Although as compared to solder cladding of the lamellas on the whole less AlSi solder is used during the coating of the flat tubes, also in the case of this powderlike coating with an AlSi(7-12) alloy due to the weight fractions of aluminum in the solder, namely, 88 wt. % to 93 wt. %, relatively large amounts of unneeded aluminum are applied to the piece. But the silicon fractions are what are mainly important for producing the intimate connection.

A better ratio of aluminum to silicon in an applied coating is disclosed in document U.S. Pat. No. 5,232,788. The solder coating consists of an aqueous slurry containing preferably Nocolok flux particles and silicon powder particles. The use of silicon powder particles instead of the AlSi(7-12) alloy particles increases the weight fraction of silicon for the brazing. The drawback, however, is that the silicon particles upon melting of the solder to produce the solder connection diffuse into the aluminum base material and form an aluminum-silicon alloy, i.e., they consume the base material. This changes the local wall thickness, which is a problem especially with thin-wall multi-chamber hollow profiles. It is no longer possible to reduce the material thickness when such is desired. Furthermore, it is necessary for the maximum silicon particle size not to exceed a value of 30 μm, since large silicon particles need to be incorporated in a correspondingly thick binder layer, which would lead to an unwanted large thickness of the solder coating layer. A relatively large thickness of binder layer is needed to incorporate the different-sized powder particles, especially the large powder particles. If the mixture of solder, flux and binder is applied in a wet coat, it is furthermore a disadvantage that a correspondingly high oven power is needed to evaporate the solvent or to dry the wet applied coat, given the large layer thickness.

Another possibility of increasing the weight fraction of silicon in the solder coating is to provide a hypereutectic aluminum-silicon alloy for the brazing solder, i.e., AlSi alloys with a weight fraction of silicon of more than 12%. The use of such hypereutectic aluminum-silicon alloys for brazing, however, has led to worse brazing results than the use of eutectic aluminum-silicon alloys or the use of silicon powder as solder. This is attributed to the fact that the primarily solidifying silicon segregations in the hypereutectic aluminum-silicon alloys on the one hand have different grain sizes and on the other hand are not homogeneously distributed in the structure of the aluminum-silicon alloy. In particular, the primarily solidified silicon particles are present in very coarse state, which can lead to a soldering erosion and thus a predamaging of the tube wall.

### SUMMARY

The problem of the present invention is to provide an improved solder for the brazing of aluminum components, especially heat exchanger components.

This problem is solved by a solder powder with the features of claim 1. This solder powder for the connection of components made of aluminum or aluminum alloys by brazing consists of powder particles on an aluminum-silicon base, wherein the weight fraction of silicon is more than 12 wt. %, preferably between 12 wt. % and 40 wt. % silicon, especially preferably 18 wt. % to 36 wt. % silicon. Thanks to the high weight fraction of silicon in this solder powder on an aluminum-silicon base, the fraction of aluminum in this solder powder is correspondingly decreased. Thus, less unneeded aluminum is used for the solder coating, which is advantageous due to the high price of aluminum. Since the powder particles of the solder powder were created by a rapid solidification, each powder particle has primary silicon crystal segregations in a eutectic aluminum-silicon alloy structure, so that the primary silicon crystal segregations are uniformly and finely distributed in the solder powder. Thus, the coating with such a solder powder leads to a uniform distribution of the silicon on the surface of the piece coated with such a solder powder and thus equally good soldering results. It is a different case with powder coatings or solder claddings made from a hypereutectic aluminum-silicon alloy, traditionally produced by foundry casting, which may contain coarse silicon segregations and furthermore do not show a uniform distribution of the silicon segregations, so that the danger of soldering erosion in particular exists.

### BRIEF DESCRIPTION OF THE DRAWINGS

FIG. 1 is an enlarged representation of the AlSi(34) alloy texture after the solidification

FIG. 2 shows for comparison a prior art hypereutectic AlSi18 alloy.

### DETAILED DESCRIPTION

The new solder powder according to the invention is achieved by rapid solidification of a hypereutectic aluminum-silicon alloy melt. For example, such a solder powder can be obtained from a hypereutectic aluminum-silicon alloy melt, whose content of silicon can be adjusted to the desired weight fraction of silicon, by atomization at high cooldown rates of 10³ to 10⁷ K/s. For this, the aluminum-silicon alloy melt is supplied to a nozzle and the melt jet is atomized by means of an inert process gas. The resulting droplets of molten metal are cooled down by the process gas until solidification. Thanks to the rapid quenching of the melt droplets, the state prevailing in the melt is virtually frozen in place. The resulting powder particles have no coarse phases in their texture. The structure is homogeneous and finely dispersed. The primary silicon segregations are homogeneously distributed in each powder particle. The result is an ultrafine microstructure. Another method of producing rapidly solidified powder particles is the so-called melt spinning technology.

In advantageous manner, overspray from rapid solidification processes such as melt spinning processes or spray compacting processes which arises in the production of other products can also be used as solder powder. In order to use such an overspray as a solder powder, however, the powder should contain less than 0.1 wt. % copper, less than 0.3 wt. % iron and less than 5 wt. % rare earths.

In known brazing coatings, besides the solder and flux there is also provided a zinc coating to heighten the corrosion resistance of the aluminum pieces. A zinc fraction can also be provided when using the solder powder of the invention for the coating of an aluminum piece, wherein the zinc fraction on the one hand can be provided as part of the flux, such as potassium fluorozincate, or the zinc is a solder powder component. In this case, up to 12 wt. % zinc, preferably up to 10 wt. % zinc, is added to the aluminum-silicon alloy melt before the rapid solidification process begins. The zinc is then preferably contained in dissolved form in the resulting solder powder.

In the same fashion, other alloy components can be added as individual elements or as prealloys to the aluminum-silicon alloy melt prior to the solidification process, such as those for hydride forming agents, which bind to the available hydrogen during the solidification process. Possible for this purpose are alkaline earth metals of the transitional metals, such as calcium, barium, zirconium or titanium. Furthermore, components which contribute to grain reduction can be added to the aluminum-silicon alloy components, such as sodium, strontium, phosphorus, germanium, indium, bismuth, antimony or beryllium. Beryllium is also furthermore used as a magnesium blocker, since magnesium adversely affects a flux. Preferably not more than 0.2 wt. % of each individual component of these is used and overall not more than 0.5 wt. %.

Another advantage of the production method for the solder powder is that powder particles of a relatively uniform powder particle size can be obtained. The particle size is limited for use of the rapidly solidified powder particles. The particles should not be larger than 80 μm. Preferred is a particle size distribution with a mean particle size between 5 and 30 μm, and preferably the mean particle size is between 10 and 20μ. In order to achieve such a particle size distribution, the powder particles after the rapid solidification are optionally taken on to one or more sifting and/or screening procedures.

Such a solder powder according to the invention is used in particular for the coating of heat exchanger components, preferably for the coating of the extruded flat tubular sections of the heat exchanger, so that these can be connected by means of a brazing connection to the manifold sections and the lamellas arranged between the flat tubular sections. The flat tubular sections are preferably extruded hollow profiles. For use as heat exchangers, multi-chamber hollow profiles (MP profiles) or especially preferably micro-multi-chamber profiles (MMP profiles) are employed. The coating of the extruded flat tubular sections can be done directly after the extrusion process, i.e., inline with the extrusion process. It is advantageous to apply the coating needed for the brazing on the still warm extruded string of flat tubular section. However, a coating can also be done in a separate process step.

Together with the solder powder, a flux is preferably applied at the same time during the coating of the aluminum pieces, especially the extruded flat tubular sections of a heat exchanger. Various fluxes can be considered. The choice is made according to the desired soldering process. For oven soldering under a protective gas atmosphere, for example, a familiar Nocolok flux is used, namely, a potassium fluoroaluminate, optionally with additives of zinc, i.e., a potassium fluorozincate. More recent Nocolok fluxes additionally contain lithium fluoroaluminate. The mixture of solder powder and flux can also furthermore contain fractions of cesium fluorometallates. These flux fractions are especially advantageous when the base material of the flat tubular section is an aluminum alloy with a magnesium fraction. The fractions of cesium fluorometallate in the flux then lead to a reduction of the melting point, which makes the flux more compatible with such aluminum alloys The solder powder of the invention and the flux can be applied as a dry solder-flux mixture to the flat tubular sections, in which case the flux is preferably a mixture of potassium fluorometallate and an additive of 1 wt. % to 10 wt. % of lithium fluorometallate or the flux additionally contains cesium fluorometallate, preferably 1 wt. % to 40 wt. % of cesium fluorometallate in terms of the quantity of flux. A dry application (dry fluxing) has the advantage over a solder-flux mixture prepared as a paste and aqueous suspension, i.e., a wet coating, that there is no subsequent drying of the components. Furthermore, a wet coating has the drawback that the slurries in circulation can take up impurities. In a dry-fluxing method, the dry powder mixture is applied to the components electrostatically in particular, or by means of plasma coating, and this as less than 20 g/m2 of powder particles in relation to the surface of the flat tubular sections, preferably 10 to 20 g/m2. The fraction of fluxes on the surface of the flat tubular sections should be 2 to 15 g/m2, preferably 3 to 7 g/m2.

For a better adhesion of the solder powder particles and flux powder particles, the coating mixture for the flat tubular sections can also contain a binder in familiar manner. A dry mixture for the coating of heat exchanger components of aluminum or aluminum alloys for brazing contains in one preferred embodiment the solder powder of the invention together with a flux powder and a binder powder, wherein the mixture contains preferably 20 to 40 wt. % solder powder, 25 to 60 wt. % flux powder, and 4 to 20 wt. % binder powder. As the binder powder particles one uses powder particles of ethyl celluloses, polyurethanes, polyacrylates, poly(meth)acrylates, polyamines, polyvinyl alcohols and thickeners such as gelatin, polyethylene glycols or pine resins, preferably less than 20 wt.

During a wet coating of the flat tubular sections, this mixture of solder powder, flux powder and binder powder is dispersed uniformly in a solvent. This slurry is sprayed onto the surface of the flat tubular sections or applied to the flat tubular sections by means of rolling.

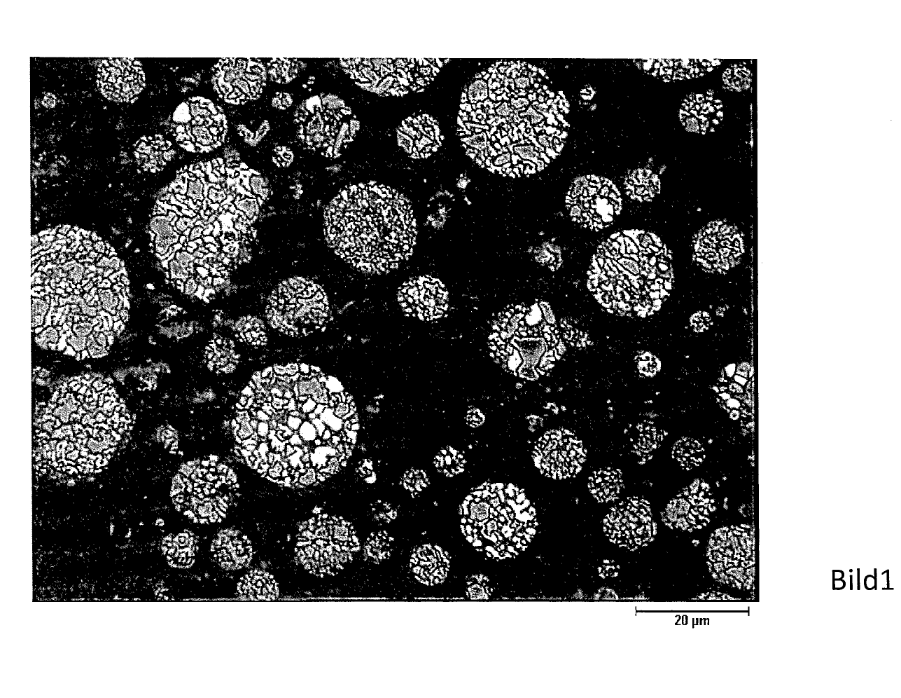

The invention shall now be described by means of a sample embodiment. The solder powder contains powder particles that were obtained by a rapid solidification from an AlSi(34) alloy melt. FIG. 1 shows an enlarged representation of the AlSi(34) alloy texture after the solidification. The silicon segregations have a size of 0.8 to 6.4 μm. The primary silicon crystal segregations appear dark gray against the light eutectic aluminum-silicon alloy texture. One can see that primary silicon crystal segregations are evenly distributed in each power particle.

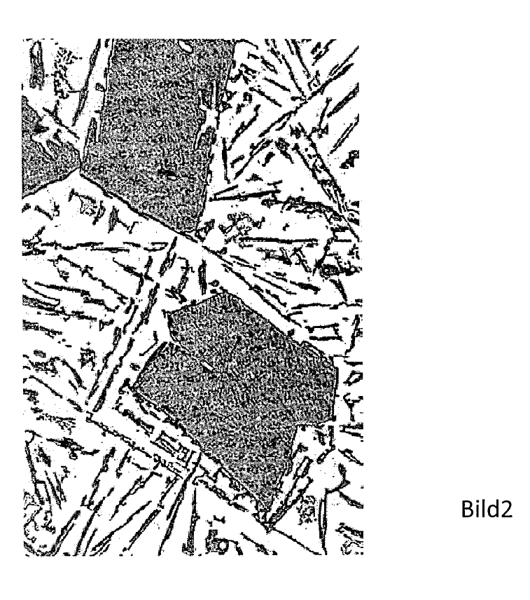

FIG. 2 shows for comparison a hypereutectic AlSi18 alloy made in the classical manner. This AlSi18 powder shows no comparable distribution of the primary silicon crystals. This picture was taken from the Aluminum Handbook, 15th edition, page 77, FIG. 3.4c.

The solder powder shown in FIG. 1 was mixed with twice the quantity of a flux powder, the flux powder containing 90% potassium fluoroaluminate and 10% lithium fluoroaluminate. These powder components are applied in a dry plasma application process to the surface of a flat tubular section and this in a quantity of 12 g/m2. The aluminum flat tubular sections so prepared are soldered under protective gas atmosphere in an oven at uniform temperature. This experiment was repeated multiple times. No soldering erosions occurred.

1-16. (canceled)

17. Solder powder for connection of components made of aluminum or aluminum alloys by brazing consisting of:
powder particles on an aluminum-silicon base with a weight fraction of more than 12 wt. % silicon,
wherein the powder particles are produced by rapid solidification of a melt on an aluminum-silicon base at high cooldown rates, in particular of 10³ to 10⁷ K/s,
the powder particles have a maximum particle size of 80 μm,
the powder particles contain evenly distributed silicon primary crystal segregations in the eutectic aluminum-silicon alloy structure and
the powder particles comprise no coarse silicon primary crystal segregations in the structure.

18. Solder powder according to claim 17, wherein the particle size distribution shows particles with a particle size of 5 to 30 μm, wherein the mean particle size is preferably between 10 and 20 μm.

19. Solder powder of claim 1 wherein the powder particles are produced by atomization of a melt on an aluminum-silicon base, and the desired particle distribution was possibly obtained by subsequent screening processes.

20. Solder powder of claim 1 wherein the powder particles on an aluminum-silicon base contain 12 to 40 wt. % silicon, preferably 18 to 36 wt. % silicon.

21. Solder powder of claims 1 wherein the powder particles on an aluminum-silicon base contain up to 12 wt. % zinc, preferably up to 10 wt. % zinc.

22. Solder powder of claims 1 wherein the powder particles on an aluminum-silicon base contain
12 to 40 wt. % silicon,
at most 12 wt. % zinc,
at most 0.1 wt. % copper,
at most 0.3 wt. % iron,
at most 5 wt. % rare earths,
at most 0.2 wt. % of one or more other alloy components, individually or
at most 5 wt. % of one or more other alloy components in total,
and the rest aluminum.

23. Heat exchanger made from components made of aluminum or an aluminum alloy, namely from extruded flat tubular sections, from lamellas which are arranged between the flat tubular sections and from manifold sections, into which the flat tubular sections are introduced at the end side wherein the flat tubular sections are coated with a solder powder according to claim 17.

24. Heat exchanger according to claim 23, wherein the flat tubular sections are coated with a mixture of the solder powder and of a flux powder, wherein the flux is a mixture of potassium fluorometallate and an additive of 1 wt. % to 10 wt. % lithium fluorometallate.

25. Heat exchanger according to claim 24, wherein the flat tubular sections are coated with a mixture of the solder powder and of a flux, wherein the flux additionally contains cesium fluorometallate, preferably 1 wt. % to 40 wt. % cesium fluorometallate relative to the quantity of flux.

26. Heat exchanger according to claim 24 wherein less than 20 g/m², preferably 10 to 20 g/m², of the mixture of the solder powder and of the flux is applied to the surface of the flat tubular sections.

27. Heat exchanger according to claim 23, wherein zinc is contained in the mixture of the solder powder and of the flux as a solder powder ingredient and/or as potassium fluorozincate.

29. Heat exchanger of claim 23 wherein the dry powder particles are applied by electrostatic coating or plasma coating to the flat tubular sections.

30. Heat exchanger of claim 23 wherein the powder particles are applied as a wet slurry by spraying or roller coating to the flat tubular sections.

31. Heat exchanger according to one of claims 23 wherein the flat tubular sections are extruded hollow profiles, preferably multi-chamber profiles (MP profiles), especially preferably micro-multi-chamber hollow profiles (MMP profiles).

32. Dry mixture for coating of heat exchanger components made of aluminum or aluminum alloys for brazing, containing a mixture of solder powder according to claims 17, a flux powder, and possibly a binder powder, wherein the mixture preferably contains 20 to 40 wt. % solder powder, 25 to 60 wt. % flux powder and up to 20 wt. % binder powder.
